(19) United States
(12) Patent Application Publication
(10) Pub. No.: US 2010/0053424 A1
(43) Pub. Date: Mar. 4, 2010

(54) VIDEO SIGNAL PROCESSING APPARATUS AND VIDEO SIGNAL PROCESSING METHOD

(75) Inventor: Mamoru Kobayashi, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/419,933

(22) Filed: Apr. 7, 2009

(30) Foreign Application Priority Data
Aug. 29, 2008 (JP) 2008-222295

(51) Int. Cl. H04N 7/01

(52) U.S. Cl. 348/441; 348/E07.003

(57) ABSTRACT

According to one embodiment, a video signal processing apparatus includes a detection module configured to detect a moving image area and a still image area in a plurality of successive frames generated based on a video signal, and a frame processing module configured to generate a plurality of interpolated frames used to compensate for the moving image area except for the still image area in the plurality of successive frames based on motion-compensated prediction, and to output a plurality of interpolation-processed frames, which are generated by interpolating between the plurality of successive frames using the plurality of interpolated frames.

### CROSS-REFERENCE TO RELATED APPLICATIONS

This application is based upon and claims the benefit of priority from Japanese Patent Application No. 2008-222295, filed Aug. 29, 2008, the entire contents of which are incorporated herein by reference.

### BACKGROUND

1. Field

One embodiment of the invention relates to a video signal processing apparatus and video signal processing method, which enhance a moving image presentation by interpolated frames generated based on motion-compensated prediction.

2. Description of the Related Art

In recent years, a double-speed processing technique is applied to liquid crystal TVs and the like. The double-speed processing technique is a technique for enhancing a moving image presentation using interpolated frames generated based on motion-compensated prediction. For example, a double-speed processing circuit generates an interpolated frame to be inserted between two successive frames based on motion-compensated prediction. As a result, for example, the double-speed processing circuit can convert a video picture including 60 frames/sec into that including 120 frames/sec, thus eliminating afterimages.

The aforementioned double-speed processing technique effectively functions for a moving image, but it does not often effectively function for a still image. Jpn. Pat. Appln. KOKAI Publication No. 2008-166966 discloses a technique which applies double-speed processing using interpolated frames when it is detected that a video signal corresponds to a moving image, and does not apply any double-speed processing using interpolated frames when it is detected that a video signal corresponds to a still image.

The technique disclosed in the above reference stops the double-speed processing for a video signal when the video signal corresponds to a still image.

However, some video signals include both still and moving images. As video signals including both still and moving images, for example, a video signal including side panels (frame) and that locally including a menu window are known. When the double-speed processing is stopped for these video signals, a smooth moving image presentation is disturbed. Conversely, when the double-speed processing is applied to such video signals, noise is often generated on the boundary between still and moving images.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a schematic block diagram showing the arrangement of a broadcast reception system (video signal processing apparatus) according to a first embodiment of the invention;

FIG. 2 is a schematic block diagram showing the arrangement of a broadcast reception system (video signal processing apparatus) according to a second embodiment of the invention;

FIG. 3 is a view showing a video signal including both still images (side panels) and a moving image according to the first and second embodiments;

FIG. 4 is a view showing a video signal including both a still image (menu window) and a moving image according to the first and second embodiments; and

FIG. 5 is a view showing an interpolated frame generated by still image/moving image-dependent double-speed processing according to the first and second embodiments.

### DETAILED DESCRIPTION

Various embodiments according to the invention will be described hereinafter with reference to the accompanying drawings. In general, a video signal processing apparatus according to one embodiment of the invention comprises a detection module configured to detect a moving image area and a still image area in a plurality of successive frames generated based on a video signal, and a frame processing module configured to generate a plurality of interpolated frames used to compensate for the moving image area except for the still image area in the plurality of successive frames based on motion-compensated prediction, and to output a plurality of interpolation-processed frames, which are generated by interpolating between the plurality of successive frames using the plurality of interpolated frames.

Embodiments of the invention will be described hereinafter with reference to the drawings.

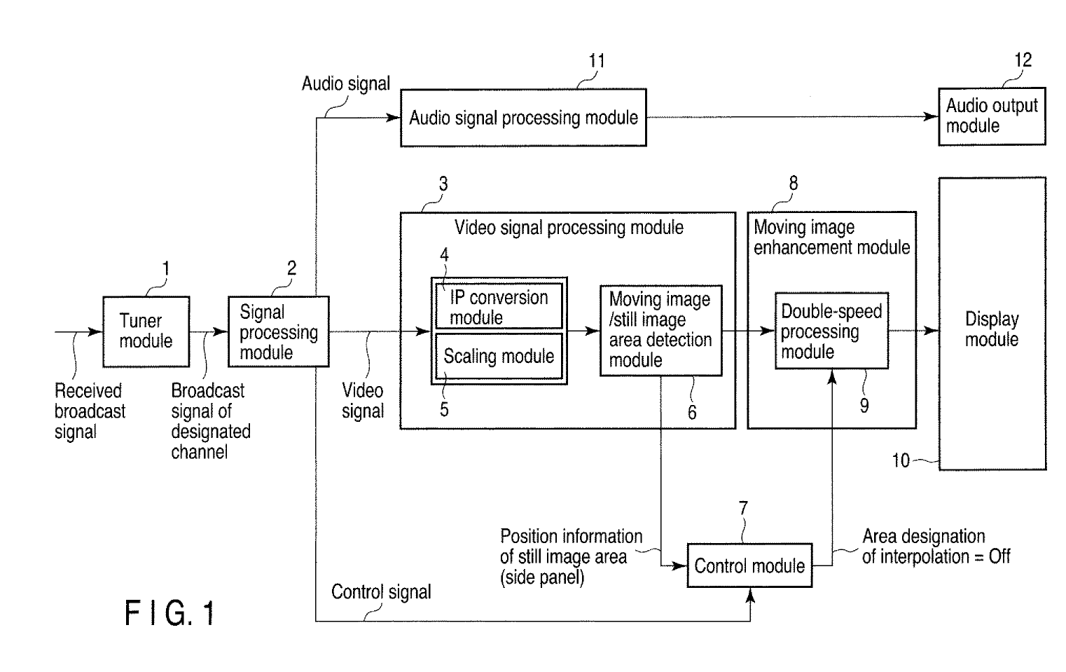

FIG. 1 is a schematic block diagram showing the arrangement of a broadcast reception system (video signal processing apparatus) according to a first embodiment of the invention.

As shown in FIG. 1, the broadcast reception system includes a tuner module 1, signal processing module 2, video signal processing module 3, IP conversion module 4, scaling module 5, moving image/still image area detection module 6, control module 7, moving image enhancement module 8, double-speed processing module 9, display module 10, audio signal processing module 11, and audio output module 12.

The tuner module 1 selects a broadcast signal of a designated channel from the received broadcast signal, and outputs the selected broadcast signal. The selected broadcast signal includes a control signal, video signal, and audio signal. The signal processing module 2 separates the control signal, video signal, and audio signal included in the broadcast signal output from the tuner module 1, and supplies the control signal to the control module 7, the video signal to the video signal processing module 3, and the audio signal to the audio signal processing module 11.

The video signal is output to the display module 10 via the video signal processing module 3 and moving image enhancement module 8. The display module 10 includes, e.g., a liquid crystal display. The audio signal is output to the audio output module 12 via the audio signal processing module 11. The audio output module 12 includes, e.g., a loudspeaker.

The IP conversion module 4 and scaling module 5 which configure the video signal processing module 3 convert the video signal into that of a display format compatible to the display module 10. For example, the IP conversion module 4 converts an interlaced video signal into a progressive video signal. The scaling module 5 scales a video picture based on the video signal in accordance with the performance of the display module 10. The moving image/still image area detection module 6 detects a moving image area and still image area included in the video signal. That is, the moving image/still image area detection module 6 detects position information (coordinate information) of a moving image area and that (coordinate information) of a still image area located in a plurality of successive frames generated based on the video signal.

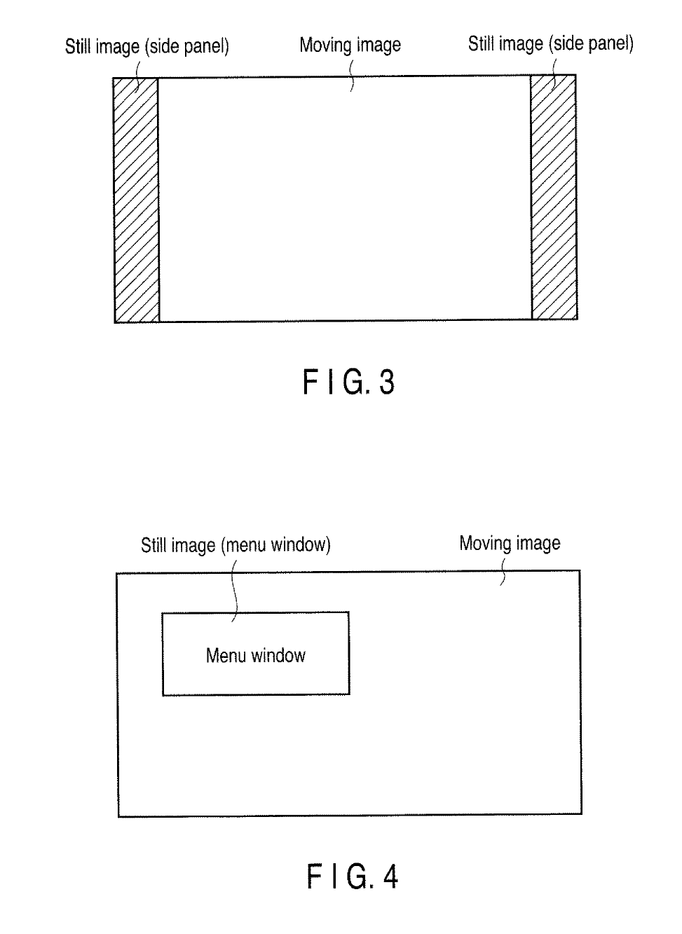

Note that examples of a still image include side panels shown in FIG. 3 and a menu window (graphic) shown in FIG. 4.

The double-speed processing module 9 which configures the moving image enhancement module 8 generates an interpolated frame to be inserted between two successive frames based on motion-compensated prediction, and converts, for example, a video signal including 60 frames/sec (a video signal at a vertical frequency of 60 Hz) into that including 120 frames/sec (a video signal at a vertical frequency of 120 Hz).

The motion-compensated prediction is a technique that compares a target image (frame 1) with a previous image (frame 0), and predicts motions of objects in the previous image. For example, with this technique, the target image and previous image are respectively divided into macroblocks (for example, a block of 16 pixels×16 lines), motion vectors which indicate the moving directions and amounts of corresponding macroblocks between the target image and previous image are prepared, and an interpolated image (interpolated frame) is predicted from the previous image based on the motion vectors

Furthermore, the double-speed processing module 9 applies still image/moving image-dependent double-speed processing to frames generated from a video signal including both still and moving images. The still image/moving image-dependent double-speed processing is processing that applies double-speed processing to a moving image part but not to a still image part. In other words, the still image/moving image-dependent double-speed processing is processing that prepares an interpolated image for a moving image part, and uses the previous image intact for a still image part in place of the interpolated image.

As described above, the moving image/still image area detection module 6 detects a moving image area and still image area included in a video signal, and notifies the control module 7 of the detection result of the moving image area and still image area (position information of the moving image area and that of the still image area). The control module 7 instructs the double-speed processing module 9 to compensate for only the moving image area except for the still image area based on the detection result of the moving image area and still image area.

in response to this instruction, the double-speed processing module 9 generates a plurality of interpolated frames used to compensate for only the moving image area except for the still image area in a plurality of successive frames based on the motion-compensated prediction, and outputs a plurality of interpolation-processed frames, which are generated by interpolating between the plurality of successive frames using interpolated frames. In other words, the double-speed processing module 9 disables the double-speed processing only for a still image part.

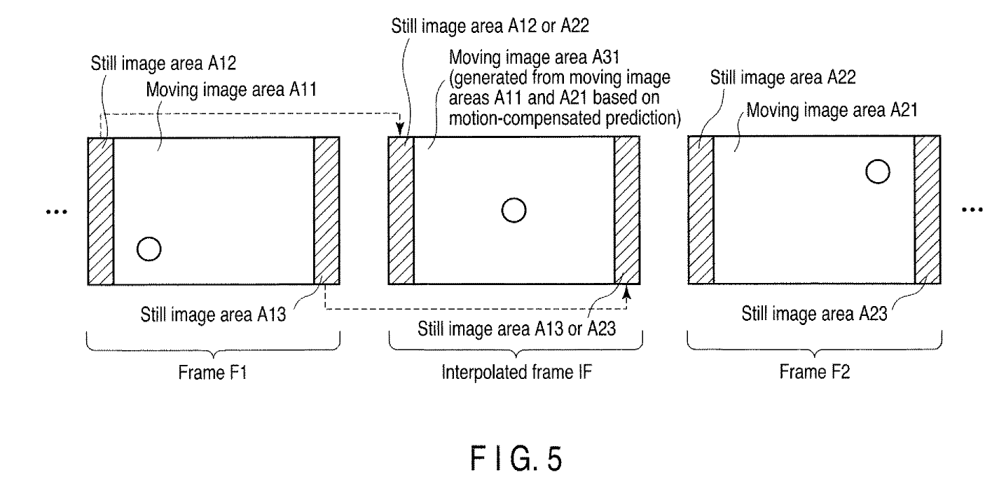

An interpolated frame generated by the still image/moving image-dependent double-speed processing will be described below with reference to FIG. 5. As shown in FIG. 5, an interpolated frame IF used to interpolate between a frame F1 and a frame F2 which follows frame F1 will be explained below.

Frame F1 including a moving image area A11, still image area A12, and still image area A13, and frame F2 includes a moving image area A21 corresponding to moving image area A11, a still image area A22 corresponding to still image area A11, and a still image area A23 corresponding to still image area A13. Note that still image regions A12, A13, A22, and A23 are, for example, black frames called side panels.

The interpolated frame IF includes an interpolated moving image area A31, which is generated from moving image areas A11 and A21 based on the motion-compensated prediction, a still image area as one of still image areas A12 and A22 (i.e., one still image area of frame F1 or F2), and a still image area as one of still image areas A13 and A23 (i.e., one still image area of frame F1 or F2).

That is, the still image of the interpolated frame IF is not an image generated based on the motion-compensated prediction, but it uses the still image of the frame immediately before the interpolated frame IF (or that of the frame immediately after the interpolated frame IF) intact. In contrast, the moving image of the interpolated frame IF is an image generated based on the motion-compensated prediction.

As a result of the aforementioned still image/moving image-dependent double-speed processing, a moving image presentation which suffers fewer afterimages can be implemented while preventing noise generated on the boundary between the still image and moving image. That is, the double-speed processing that can prevent noise generated on the boundary between the still image and moving image can be implemented.

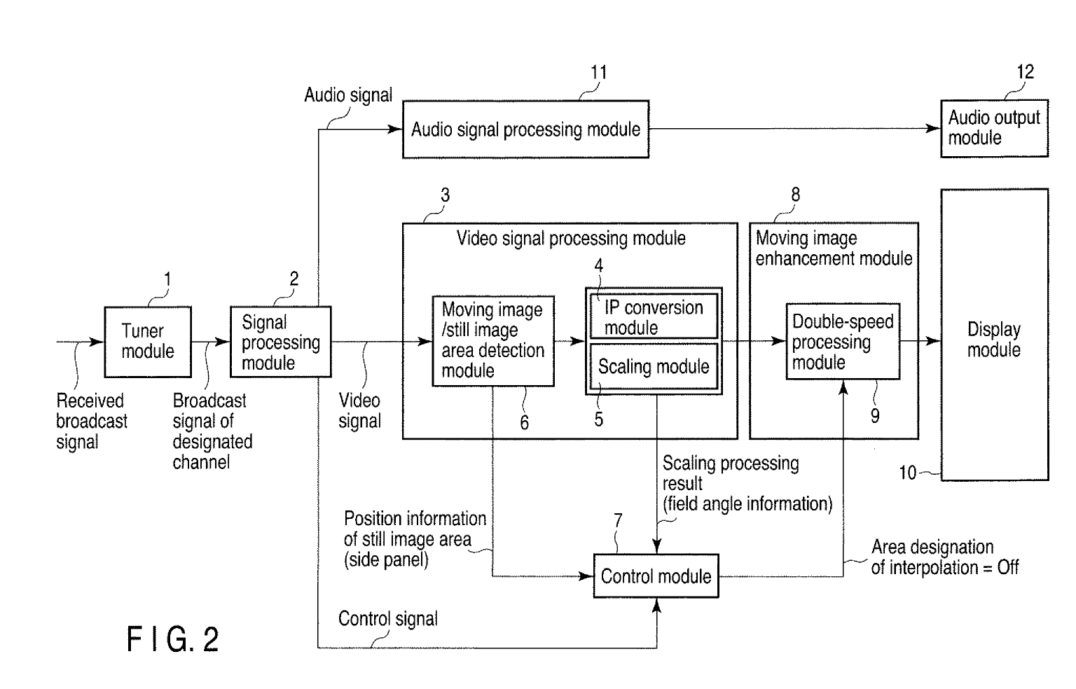

FIG. 2 is a schematic block diagram showing the arrangement of a broadcast reception system (video signal processing apparatus) according to a second embodiment of the invention. The difference between the broadcast reception system according to the first embodiment shown in FIG. 1 and that according to the second embodiment shown in FIG. 2 lies in the arrangement of the video signal processing module 3. The video signal processing module 3 of the broadcast reception system according to the first embodiment shown in FIG. 1 processes a video signal using the IP conversion module 4 and scaling module 5, and then detects a moving image area and still image area in the video signal by the moving image/still image area detection module 6. On the other hand, the video signal processing module 3 of the broadcast reception system according to the second embodiment shown in FIG. 2 detects a moving image area and still image area in a video signal by the moving image/still image area detection module 6, and then processes the video signal by the IP conversion module 6 and scaling module 5.

From such difference, the scaling module 5 of the broadcast reception system according to the second embodiment shown in FIG. 2 notifies the control module 7 of the scaling processing result (field angle information). The control module 7 determines the position of a still image area after the scaling processing based on the scaling processing result, and then instructs the double-speed processing module 9 to compensate for only the moving image area except for the still image area based on the position information of the still image area.

In response to this instruction, the double-speed processing module 9 generates a plurality of interpolated frames used to compensate for only the moving image area except for the still image area in a plurality of successive frames based on the motion-compensated prediction, and outputs a plurality of interpolation-processed frames, which are generated by interpolating between the plurality of successive frames using interpolated frames. In other words, the double-speed processing module 9 disables the double-speed processing only for a still image part after the scaling processing.

As described above, even when the video signal processing module 3 is configured to detect a moving image area and still image area before scaling processing, as shown in FIG. 2, the double-speed processing module 9 can accurately distinguish the still image area and moving image area from each other after the scaling processing, and can generate a plurality of interpolated frames used to compensate for only the moving image area. As a result, a moving image presentation which suffers fewer afterimages can be implemented while preventing noise generated on the boundary between the still image and moving image.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal processing apparatus comprising:
a detection module configured to detect a moving image area and a still image area in a plurality of successive frames generated based on a video signal; and
a frame processing module configured to generate a plurality of interpolated frames used to compensate for the moving image area except for the still image area in the plurality of successive frames based on motion-compensated prediction, and to output a plurality of interpolation-processed frames, which are generated by interpolating between the plurality of successive frames using the plurality of interpolated frames.

2. The apparatus of claim 1, wherein the frame processing module generates a predetermined interpolated frame used to interpolate between a first frame and a second frame which follows the first frame,
the first frame includes a first moving area and a first still image area,
the second frame includes a second moving image area corresponding to the first moving image area, and a second still image area corresponding to the first still image area, and
the predetermined interpolated frame includes an interpolated moving image area generated from the first and second moving image areas based on the motion-compensated prediction, and a still image area as one of the first and second still image areas.

3. The apparatus of claim 1, wherein the detection module detects a position of a side panel area corresponding to the still image area from the plurality of successive frames, and
the frame processing module generates a plurality of interpolated frames used to compensate for the moving image area except for the side panel area in the plurality of successive frames based on the position information of the side panel area, and outputs a plurality of interpolation-processed frames, which are generated by interpolating between the plurality of successive frames using the plurality of interpolated frames.

4. The apparatus of claim 1, wherein the detection module detects a position of a graphic region corresponding to the still image area from the plurality of successive frames, and
the frame processing module generates a plurality of interpolated frames used to compensate for the moving image area except for the graphic area in the plurality of successive frames based on the position information of the graphic area, and outputs a plurality of interpolation-processed frames, which are generated by interpolating between the plurality of successive frames using the plurality of interpolated frames.

5. The apparatus of claim 1, which further comprises: a scaling module configured to scale a video picture generated based on the video signal, and
in which the frame processing module detects a position of the still image area after scaling processing based on a scaling processing result of the scaling module, and generates a plurality of interpolated frames used to compensate for the moving image area except for the still image area.

6. The apparatus of claim 1, further comprising:
a selection module configured to select a broadcast signal of a designated channel including the video signal from a received broadcast signal.

7. A video signal processing method comprising:
detecting a moving image area and a still image area in a plurality of successive frames generated based on a video signal; and
generating a plurality of interpolated frames used to compensate for the moving image area except for the still image area in the plurality of successive frames based on motion-compensated prediction, and outputting a plurality of interpolation-processed frames, which are generated by interpolating between the plurality of successive frames using the plurality of Interpolated frames.
